(19) United States
(12) Patent Application Publication
(10) Pub. No.: US 2011/0260978 A1
(43) Pub. Date: Oct. 27, 2011

(54) TRANSPARENT KEYBOARD ASSEMBLY WITH UNDERLYING DISPLAY DEVICE

(75) Inventor: Glen C. Larsen, Issaquah, WA (US)

(73) Assignee: MICROSOFT CORPORATION, Redmond, WA (US)

(21) Appl. No.: 12/768,050

(22) Filed: Apr. 27, 2010

(51) Int. Cl. G06F 3/02

(52) U.S. Cl. 345/168

(57) ABSTRACT

The disclosure provides for a computer peripheral having a keyboard assembly situated over a display device that produces images which are viewable through the keyboard assembly. The keyboard assembly has a plurality of keys, each of which includes a keycap and a mechanical understructure that is at least partially transparent. The mechanical understructure is disposed between the keycap and the display device to guide reciprocating movement of the keycap toward and away from the display device. In some embodiments, the mechanical understructure may have a non-oblique planar configuration, in which a majority of its surface area is composed of planar surfaces that are parallel or perpendicular to the underlying display device.

### BACKGROUND

Computer peripherals are continually being refined to expand functionality and provide quality user experiences. One area of improvement has been to provide peripheral devices that combine keyboard-type input functionality with the ability to display output to the user. In many cases, this is implemented by providing a keyboard with a display region that is separate from the keys. For example, in a conventional keyboard layout, a rectangular liquid crystal display (LCD) can be situated above the function keys or number pad.

Another approach to combining input and output capability in a peripheral device is the use of a virtual keyboard on a touch interactive display. In this case, the display capability is provided directly on the keys: each key typically is displayed by the touch interactive device with a legend or symbol that indicates its function. The virtual keyboard approach has many benefits, including the ability to dynamically change the display for each key. Interactive touch displays are often less desirable, however, from a pure input standpoint. Specifically, touch displays do not provide tactile feedback, which can provide a more responsive and agreeable typing experience.

### SUMMARY

Accordingly, the following description is directed to a computer peripheral having a display device underlying a keyboard assembly. The keyboard assembly is configured to permit images produced by the display device to be viewed through the keyboard assembly. The keyboard assembly has a plurality of keys, each of which includes a keycap and a mechanical understructure that is at least partially transparent. The mechanical understructure is disposed between the keycap and the display device to guide reciprocating movement of the keycap toward and away from the display device. In some embodiments, the mechanical understructure may have a non-oblique planar configuration, in which a majority of its surface area is composed of planar surfaces that are parallel or perpendicular to the underlying display device. In these and other example embodiments, an optical prescription may be employed to produce a desired optical effect.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 depicts an exemplary computing system including a computer peripheral that provides the ability to display output in connection with the keys of a keyboard assembly.

FIG. 2 is an exploded view of the computer peripheral shown in FIG. 1, and shows viewable display output being provided by a display device underlying the keyboard assembly of the computer peripheral.

FIG. 3 illustrates an example of the output display capability that may be employed in connection with the computer peripheral of FIGS. 1 and 2.

FIGS. 4-6 depict exemplary structures that may be used to implement individual keys of the keyboard assembly shown in FIGS. 1 and 2.

FIG. 7 depicts an exemplary force-displacement characteristic that may be achieved for a keystroke through use of the key structures and tactile mechanisms described with reference to FIGS. 4-6.

### DETAILED DESCRIPTION

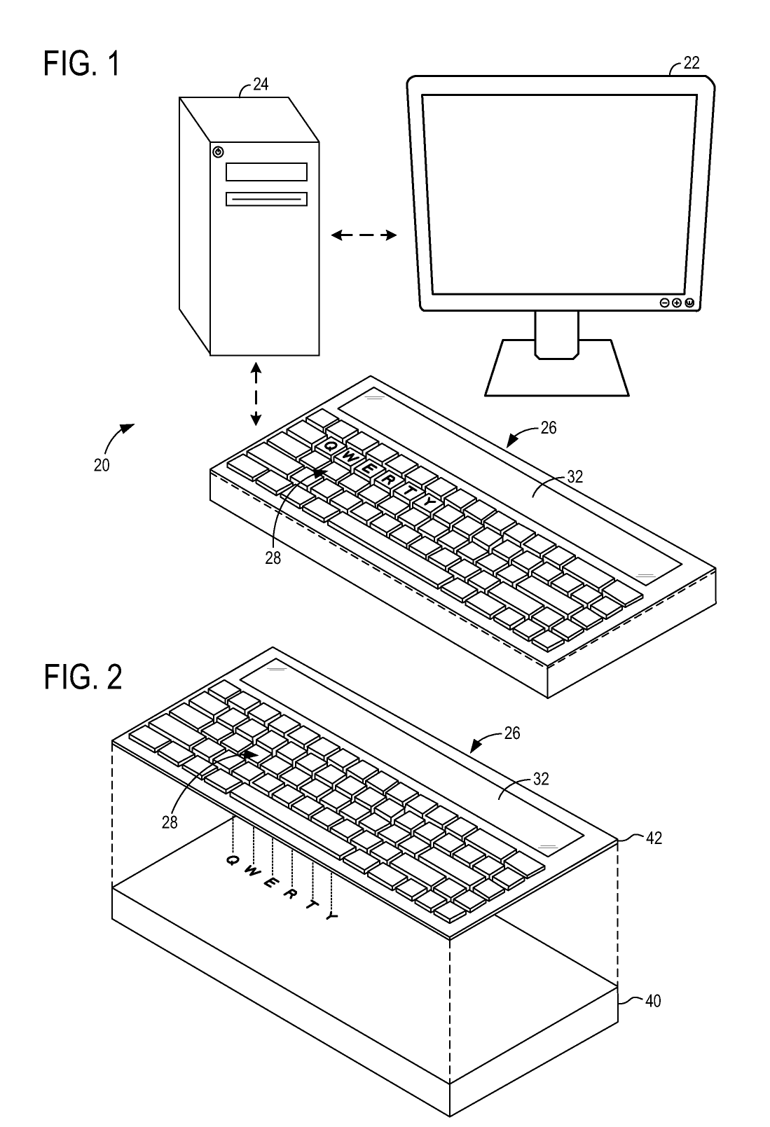

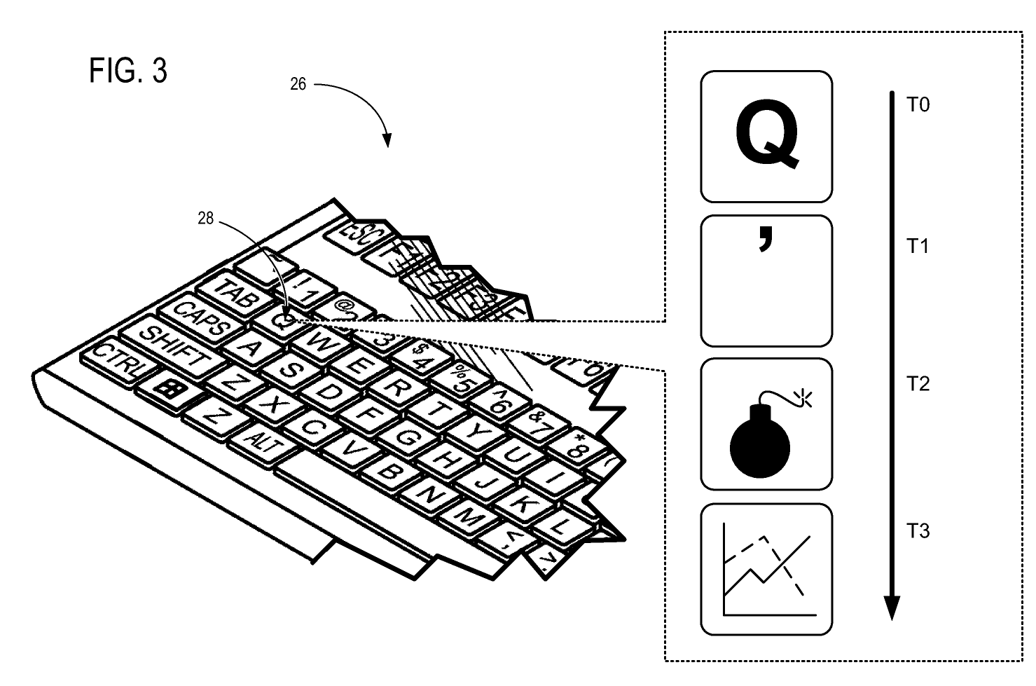

FIG. 1 depicts an exemplary computing system 20 including a display monitor 22, a component enclosure 24 (e.g., containing a processor, memory, hard drive, etc.), and a computer peripheral 26. FIG. 2 provides an additional view of computer peripheral 26 and exemplary components that may be used in its construction. As will be described in various examples, computer peripheral 26 may be implemented to provide displayable output in addition to keyboard-type input functionality. Among other things, the computer peripheral may be provided with key-movement structures that are transparent and/or that are otherwise configured to facilitate through-key viewing of images produced by a display device situated under the keys.

The terms “input” and “output” will be used frequently in this description in reference to the keyboard functionality of the exemplary computer peripherals. When used in connection with a keyboard key, the term “input” will generally refer to the input signal that is provided by the peripheral upon activation of the key. “Output” will generally refer to the display provided for a key, such as the displayed legend, icon or symbol that indicates the function of the key.

As indicated by the “Q”, “W”, “E”, “R”, “T”, “Y”, etc., on keys 28 (FIGS. 1 and 2), it will often be desirable that computer peripheral 26 be configured to provide conventional alphanumeric input capability. To simplify the illustration, many keys of FIGS. 1 and 2 are shown without indicia, though it will be appreciated that a label or display will often be included for each key. Furthermore, in addition to or instead of the well-known “QWERTY” formulation, the keys 28 of the keyboard may be variously configured to provide other inputs. Keys may be assigned, for example, to provide functionality for various languages and alphabets, and/or to activate other input commands for controlling computing system 20. In some implementations, the key functions may change dynamically, for example in response to the changing operational context of a piece of software running on computing system 20. For example, upon pressing of an “ALT” key, the key that otherwise is used to enter the letter “F” might instead result in activation of a “File” menu in a software application. Generally, it should be understood that the keys in the present examples may be selectively depressed to produce any type of input signal for controlling a computer.

Computer peripheral 26 can provide a wide variety of displayable output. In some examples, the computer peripheral causes a display of viewable output on or near the individual keys 28 to indicate key function. This can be seen in FIGS. 1 and 2, where instead of keys with letters painted or printed onto the keycap surface, a display mechanism (e.g., a liquid crystal display (LCD) device situated under the keys) is used to indicate the “Q”, “W”, etc. functions of the keys. This dynamic and programmable display capability facilitates potential use of the computer peripheral 26 in a variety of different ways. For example, the English-based keyboard described above could be alternately mapped to provide letters in alphabetical order instead of the conventional “QWERTY” formulation, and the display for each key could then be easily changed to reflect the different key assignments.

The display capability contemplated herein may be used to provide any type of viewable output to the user of computing system 20, and is not limited to alphabets, letters, numbers, symbols, etc. As an alternative to the above examples, images may be displayed in a manner that is not necessarily associated in a spatial sense with an individual key. An image might be presented, for example, in a region of the keyboard that spans multiple keys. The imagery provided need not be associated with the input functionality of the keyboard. Images might be provided, for example, for aesthetic purposes, to personalize the user experience, or to provide other types of output. Indeed, the present disclosure encompasses display output for any purpose. Also, in addition to display provided on or near keys 28, display functionality may be provided in other areas, for example in an area 32 located above keys 28. Still further, area 32 or other portions of computer peripheral 26 may be provided with touch or gesture-based interactivity in addition to the keyboard-type input provided by keys 28. For example, area 32 may be implemented as an interactive touchscreen display, via capacitance-based technology, resistive-based technology or other suitable methods.

Turning now to FIG. 2, computer peripheral 26 may include a display device 40 and a keyboard assembly 42 disposed over and coupled with the display device. Keyboard assembly 42 may be at least partially transparent, to allow a user to view images produced by the display device through the keyboard assembly. In one embodiment, for example, a scissors assembly or other mechanical understructure is provided for each key to guide and constrain inward and outward movement of the keycap, and the understructure is fashioned at least in part from a transparent material. Furthermore, the understructure may be implemented with a non-oblique planar construction, in which a majority of its surface area is formed from planar surfaces that are either parallel or perpendicular to the underlying display device. Such a non-oblique planar construction may limit refraction and other undesirable effects upon the image light being viewed through the keyboard assembly.

In addition to or instead of a non-oblique planar construction, the material of the understructure may be configured to provide a desired optical effect. For example, the material may be formed with an optical prescription to provide magnification/demagnification, blur, or another desired optical effect or outcome.

In many of the examples discussed herein, the mechanical understructure for each keycap is implemented as a pivoting scissors assembly. It will be appreciated, however, that a variety of other understructures may be employed, including post-and-plunger arrangements; elastically-collapsible dome structures; mechanically-switched keys; cantilevered mechanisms; buckling springs and other types of springs; membrane-type movements; etc. Regardless of the particular configuration, the understructures typically will be at least partially transparent, and may also be configured as mentioned above to reduce refraction and other undesirable effects upon image light, and/or configured intentionally to produce magnification, blur or another desired optical effect.

A variety of types of display device 40 may be employed. As indicated briefly above, one type of suitable display device is an LCD device. Indeed, LCD devices will be frequently referred to in the examples discussed herein, though this is non-limiting and it should be appreciated that the keyboard assembly may be coupled with a variety of other display types.

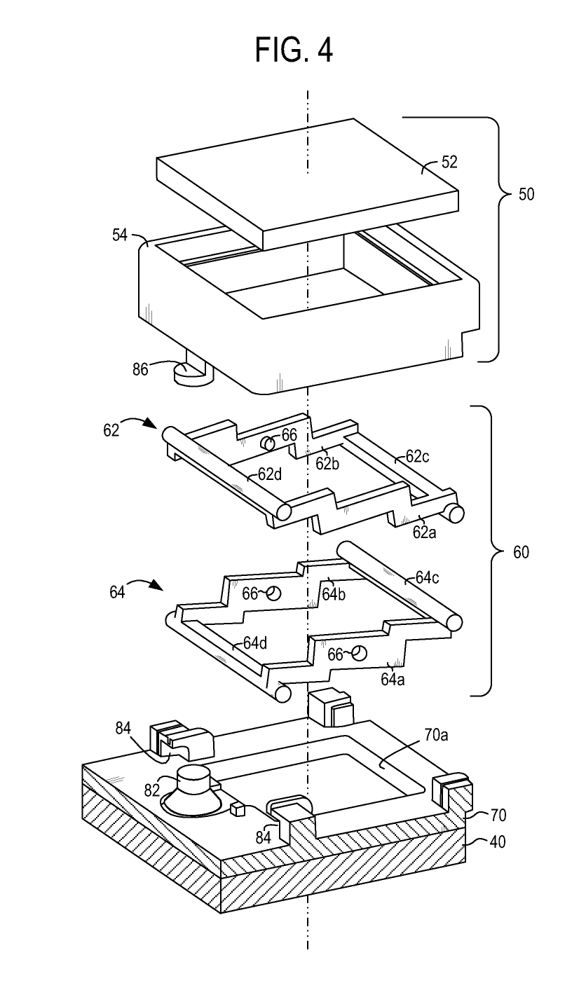

FIG. 3 provides further illustration of how the display capability of computer peripheral 26 may be employed in connection with an individual key 28. In particular, as shown respectively at times T₀, T₁, T₂, etc., the display output associated with key 28 may be changed, for example to reflect the input command produced by depressing the key. However, as previously mentioned, the viewable output provided by the computer peripheral may take forms other than displays associated with individual keys and their input functionality.

As in the examples of FIGS. 1 and 2, keyboard assembly 42 typically will include a plurality of keys employing some type of movement mechanism that enables the keys to be depressed or otherwise moved to produce an input signal. Although the term “keys” will be used primarily, this term is non-limiting, and should be understood to include buttons and any other structure or mechanism that may be moved by a user to provide input.

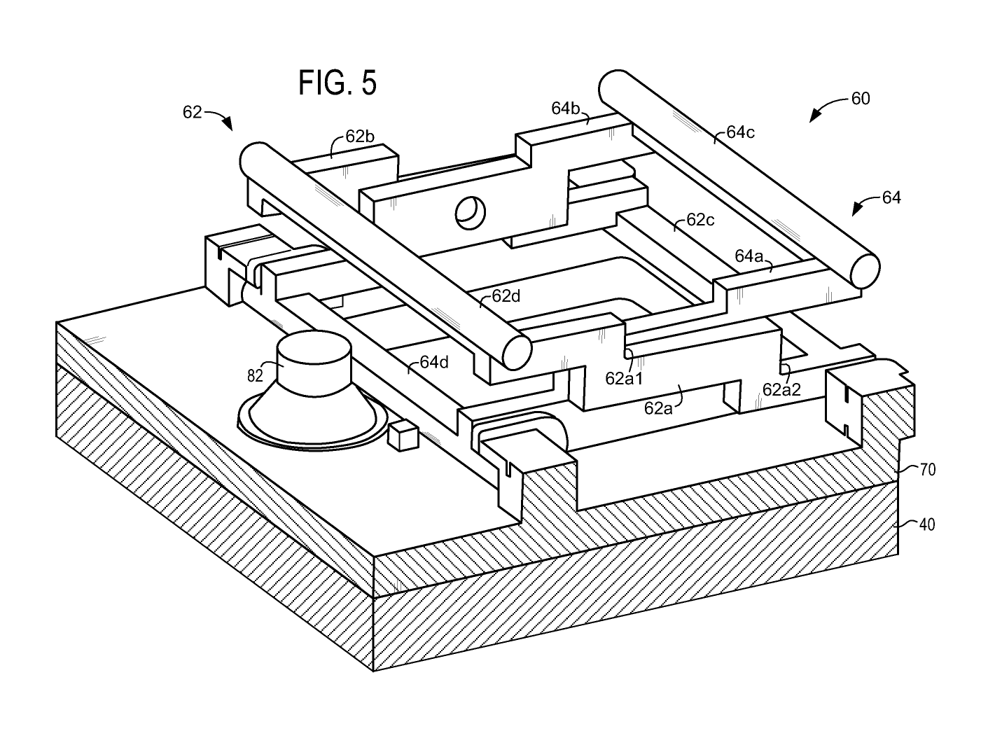

Referring now to FIG. 4, key 28 may include a keycap 50 which is pressed by the user to operate the key and cause the corresponding input signal to be generated. Because it will normally be desirable to have images from display device 40 viewable through the key, some or all of keycap 50 may be formed from a transparent material, such as a polycarbonate, acrylic or other suitable material. Keycap 50 may include, for example, an optical element 52 to enable images from the underlying display device to be viewed through the center of the key. Optical element 52 may be implemented as or include one or more of a lens, optical pillar, prism, turning film, etc., as desired, in order to facilitate through-key image viewing. In some cases, as in the depicted example, optical element 52 is formed as an insert which is disposed in or held by perimeter piece 54. In some example embodiments, perimeter piece 54 will also be transparent, in order to increase light transmission and improve image viewing through the keyboard assembly. In other examples, the perimeter piece may be opaque. In other embodiments, the optical element 52 and/or perimeter piece 54 may be translucent or have a partially translucent or partially transmissive coating, allowing some, but not all light to pass through the keys, in order to achieve a particular look or industrial design (ID) when the display is on or off.

The keyboard assembly examples described herein may also be adapted so that the keys provide a satisfying physical/mechanical feel during typing. Each key is thus configured to move reciprocally inward and outward relative to the display device. As explained in more detail below, it will also be desirable in many cases to employ tactile structures so that the force-displacement characteristic of each key provides a “snapping” action, or other tactile feedback, which can be felt by the user when the key is operated.

A mechanical understructure, such as scissors assembly 60, may be disposed between keycap 50 and display device 40, in order to guide and constrain the upward and downward movement of the keycap. Scissors assembly 60 typically guides and constrains the movement, so that the keycap moves perpendicularly inward and outward relative to display device 40, and is prevented from twisting, tilting, etc. Scissors assembly 60 may also be configured to provide some resiliency, so that keycap 50 is urged back into a non-depressed rest position when released by a user (i.e., spaced away from the display device). In addition to or instead of the resiliency being provided by the scissor assembly, a tactile structure may be provided to impart a desired mechanical feel and action to the key, as will be explained in more detail below.

Scissors assembly 60 may be coupled directly between keycap 50 and display device 40 or, as in the present example, a base structure 70 may be employed. In one example embodiment, base structure 70 covers the entire area of the keyboard assembly. The base structure is attached to the display device, and provides a base to which the keycaps are movably attached (e.g., via a scissor assembly or other mechanical understructure for each keycap). As indicated, base structure 70 may be provided with a hole 70a for each key, which is generally centrally aligned with keycap 52 to enable optimal viewing of the underlying display device. The dashed-line axis in FIG. 4 indicates an exemplary central alignment that may be employed for the keycap, scissors assembly, and hole of the base structure. In addition to or instead of holes 70a, the base structure may be made transparent to facilitate through-key image viewing. When employed, base structure 70 may also be used to hold a tactile structure and related switch for each key, as will be explained in more detail below.

Referring now to FIGS. 4 and 5, the movement mechanism that may be employed for each key will now be described in greater detail. FIG. 5 is an isometric view of scissors assembly 60 in a rest position, in which its supported keycap (not shown in FIG. 5) has not been depressed by the user toward base structure 70 and display device 40. As shown in the figures, scissors assembly 60 may include a pair of rigid structures 62 and 64 that are movably coupled with respect to each other via pivoting connections 66 (FIG. 4). Each rigid structure may include a pair of opposed legs (e.g., legs 62a and 62b of rigid structure 62; and legs 64a and 64b of rigid structure 64). For each rigid structure, a pair of opposed rods extends between the opposed legs (e.g., rods 62c and 62d of rigid structure 62; and rods 64c and 64d of rigid structure 64).

In the example embodiment, legs 62a and 64a are pivotably connected together, as are legs 62b and 64b. Thus, when the keycap supported by the scissors assembly is depressed toward display device 40, the rigid structures pivot relative to one another and the scissors assembly undergoes an effective lowering/flattening. Rods 64c and 62d abut and engage with the underside of keycap 50, while rods 64d and 62c engage and abut with base 70 (or with the surface of display device 40 if a separate base structure is not employed).

To engage the rods with keycap 50 and base structure 70, the rods may be received into or by snap hooks, pockets, or other appropriate engagement structures. At both the keycap and the base structure (e.g., at the underside of keycap 50), at least one of the rod engagements will typically be configured to accommodate sliding or other relative lateral movement of the rod, to provide tolerance for a slight overall lengthening of the scissors assembly when it is depressed. For example, as indicated in FIG. 4, base structure 70 may be provided with pockets 84 that maintain the vertical position of rod 64d during operation of the scissors assembly, while at the same time permitting a slight lateral movement of the rod.

Various materials and constructions may be used in connection with a scissors assembly or other mechanical understructure. Some or all of the structure may be made transparent and/or positioned so as to enhance or minimize interference with the display capability provided by the underlying display device. Material and construction choices may also be affected by considerations relating to stiffness, constraining the key movement to a particular direction, preventing tilting of the keys, etc. In scissor implementations, for example, it may be desirable to form the rods of the scissors assembly using metal, to provide more stiffness and stability. Such an approach might be appropriate, for example, in scissors assemblies for larger keys, such as the space bar.

Referring now to FIG. 6, the figure shows a top view of exemplary key 28, with upward-facing portions/surfaces of scissors assembly 60 being visible through perimeter piece 54 of keycap 50. As in the depicted example, it may be desirable in some embodiments to configure or otherwise arrange the movement-related structures of the key (e.g., scissors assembly 60) so that they are positioned toward the perimeter of the key. Specifically, the legs and rods of the scissors assembly (i.e., legs 62a, 64a, 62b and 64b; and rods 62c, 64c, 62d and 64d) may all be positioned at or toward outer edges of keycap 50. These structures then collectively define an aperture 60a through the scissors assembly 60. Typically, the aperture is centrally aligned with the key and with the corresponding display area associated with the key (i.e., the area on display device 40).

The example of FIG. 6 shows that, while scissors assembly 60 is disposed toward the edges of the key, its structures are still located underneath the key. It will be appreciated, however, that embodiments are possible where some or all of the scissors assembly is positioned outside the outer edges of the key.

Even when the scissors assemblies are positioned away from the key centers, the scissors assemblies do take up space on keyboard assembly and thus have the potential to affect the ability to view images through the keyboard assembly. A first effect to be considered is the blocking of light rays from the underlying display device. This consideration will inform embodiments in which structures of the scissors assembly are positioned to avoid blocking of images from the display device. As discussed above, one general approach will involve keeping the scissors assembly structures away from the key center (e.g., toward the edges or periphery of the keycap).

Another example would be to configure the scissors assemblies based on the types of images that are to be viewed through the keyboard assembly. In some embodiments, for example, it might be desirable to have words or other multi-character legends displayed for an individual key. In such a case, it would be potentially be preferred to have the aperture through the scissors assembly be relatively wider than it is tall. This can be achieved by configuring the relative lengths of the rods and legs of the scissors assembly, and/or through a particular rotational orientation of the scissors assembly. For example, depending on the particular implementation, the spacing between the rods of the scissors assembly might be different than the spacing between the legs.

In addition to or instead of the non-blocking approach, some or all of a scissors assembly or other mechanical understructure may be made transparent to permit image light to passage of light. Polycarbonates, acrylics or other suitable transparent materials may be employed.

In transparent configurations, some or all of the mechanical understructure may be implemented using a non-oblique configuration, in which a majority of the surface area is substantially parallel or perpendicular to the image plane of the display device. Referring specifically to FIG. 5, for example, leg 62a of the depicted scissors assembly is configured so that its surfaces are planar. The configuration also includes stepped transitions 62a1 and 62a2 between adjoining upward-facing planar surfaces, to achieve a relative difference in height between opposed ends of leg 62a. Similar constructions may be employed for the other legs. Accordingly, when the scissors assembly is in the rest position of FIG. 5 (i.e., its supported keycap is not depressed downward toward base structure 70 and display device 40), the planar exterior surfaces of the legs are all either parallel or perpendicular to the plane of the display device. In some settings, this non-oblique configuration of the surfaces can facilitate the display capability, for example by minimizing distortion, refraction, internal reflection or other effects upon the light rays produced by display device 40.

In addition to or instead of the non-oblique planar configuration, the material and surfaces of the mechanical understructure may be configured to produce various desired optical effects. Such effects may include magnification, demagnification, blur, etc., to name but a few examples. For example, the upward-facing surfaces of leg 62a may be formed with optical curvature or another appropriate optical prescription to achieve magnification, demagnification, blur or another desired optical outcome.

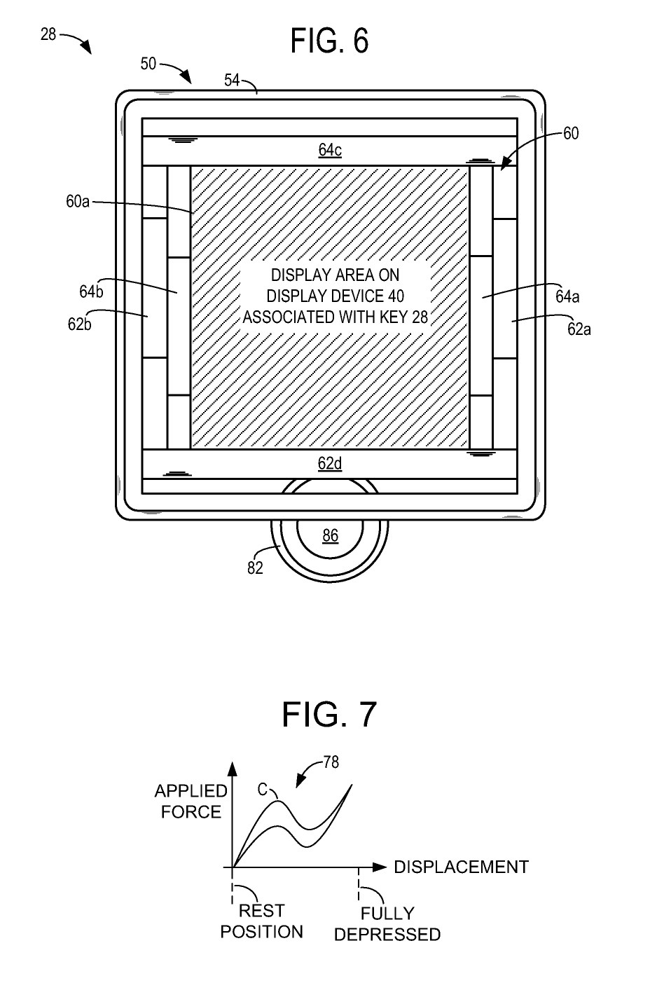

Tactile structures may be employed for each key, to provide tactile user feedback when the key is depressed from its rest position toward the underlying display device. The tactile structures may be elastically deformable, so that the tactile structure collapses as the key approaches its fully depressed position, and then bounces back to its original shape/position as the key is released. This can provide the keystroke with a non-linear force-displacement characteristic. An example of such a characteristic is shown in FIG. 7 at 78. The upper portion of the characteristic corresponds to the key being depressed; the lower corresponds to release of the key. As seen in the characteristic, as the key is displaced from a rest position toward being fully depressed, a relatively higher amount of force is needed to move the key through the initial part of its range. At some point, the tactile structure collapses, as indicated by the corner C in the characteristic. This collapse is tangibly felt by the user, and provides affirming feedback that the key has been actuated.

In the present examples, the tactile structures are implemented as elastically-deformable tactile feedback domes, as indicated at 82 in FIGS. 4, 5 and 6. As shown in FIGS. 4 and 6, the keycap may be provided with a tab 86 or other structure to press down upon and collapse the tactile feedback dome 82 when the key is depressed. Instead of domes, the tactile structures may be implemented using springs, wires, or other structures to provide the desired tactile user feedback.

The tactile structures may interact with other components to provide electrical switching and produce input signals in response to operation of the keys. For example, base structure 70 may be provided with a three-layer electrical contact construction, in which two conducting layers are separated by an insulating layer. Switching is then performed by interaction of the tactile structure with the three layers. Specifically, depressing the key causes the tactile structure to collapse and press against the layers to produce a resilient deformation, in which the two conductive layers are brought into electrical contact through a hole in the insulating layer. This electrical contact produces the input signal. It should be understood, however, that this is but one non-limiting example of how switching may be performed.

As discussed above, various components of the keyboard assembly may be configured to facilitate through-key viewing of images from the underlying display device 40. In some example embodiments, the components are centrally aligned to increase the ability of the user to see the underlying display. For example, scissors assembly 60 and/or base structure may be provided with openings that are aligned with the centers of the keycaps. When employed, tactile structures may be centrally offset from the centers of the keycaps, as shown in FIGS. 4, 5 and 6. This centrally-offset location of the tactile structure reduces the potential that the tactile structure will obscure viewing of images through the central portion of the key.

Computing systems such as that depicted in FIG. 1 may include various components to implement functionality in connection with the computer peripheral examples discussed herein. The input and output functionality of the example computer peripherals may be carried out, for example, using instructions that are executed by a processor or other logic subsystem. The processor may execute these instructions as part of one or more programs, routines, objects, components, data structures, or other logical constructs. Such instructions may be implemented to perform a task, implement a data type, transform the state of one or more devices, or otherwise arrive at a desired result.

The executable instructions may be held, along with other data, in any appropriate data-holding subsystem. When instructions are executed to carry out the methods and processes described herein, the result may include the transformation of data held in the data-holding subsystem. Data may be held on removable and/or built-in devices/media, including optical memory devices, semiconductor memory devices, and/or magnetic memory devices, among others. Suitable data-holding devices/media may have one or more of the following characteristics: volatile, nonvolatile, dynamic, static, read/write, read-only, random access, sequential access, location addressable, file addressable, and content addressable.

Display device 40 may form part of a computing system's display subsystem. As the herein described methods and processes change the data held by the data-holding subsystem, and thus transform the state of the data-holding subsystem, the state of display subsystem may likewise be transformed to visually represent changes in the underlying data. For example, the visual output from display device 40 that is viewable through keyboard assembly 42 may change.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A computer peripheral, comprising:
a display device; and
a keyboard assembly disposed over the display device and configured to permit viewing of images produced by the display device through the keyboard assembly, the keyboard assembly including a plurality of keys, wherein each of the plurality of keys includes a keycap and a mechanical understructure that is at least partially transparent, the mechanical understructure being disposed between the keycap and the display device to guide reciprocating movement of the keycap toward and away from the display device.

2. The computer peripheral of claim 1, wherein the mechanical understructure is a scissors assembly having a first rigid structure and a second rigid structure that are pivotably coupled with respect to each other.

3. The computer peripheral of claim 2, wherein each of the first rigid structure and the second rigid structure includes a pair of opposed legs held spaced apart by a pair of opposed rods, and wherein a first one of the pair of opposed legs of the first rigid structure is pivotably coupled to a first one of the pair of opposed legs of the second rigid structure, and wherein a second one of the pair of opposed legs of the first rigid structure is pivotably coupled to a second one of the pair of opposed legs of the second rigid structure.

4. The computer peripheral of claim 3, wherein for each of the first rigid structure and the second rigid structure, each of the pair of opposed legs has a stepped, non-oblique configuration, in which a majority of surface area of the opposed leg is substantially parallel or substantially perpendicular to the display device when the scissors assembly is in a non-depressed rest position.

5. The computer peripheral of claim 4, wherein the keyboard assembly further includes a base structure disposed over the display device, with the keycap for each of the plurality of keys being movable toward and away from the base structure, wherein a tactile structure is provided on the base structure for each of the plurality of keys to provide tactile user feedback when the keycap is depressed toward the base structure and display device.

6. The computer peripheral of claim 3, wherein for each of the first rigid structure and the second rigid structure, each of the pair of opposed legs and each of the pair of opposed rods are disposed toward a periphery of the keycap, thereby leaving a central aperture through the scissors assembly.

7. The computer peripheral of claim 1, wherein the keyboard assembly further includes a base structure disposed over the display device, with the keycap for each of the plurality of keys being movable toward and away from the base structure, wherein a tactile structure is provided on the base structure for each of the plurality of keys to provide tactile user feedback when the keycap is depressed toward the base structure and display device.

8. The computer peripheral of claim 7, wherein for each of the plurality of keys, the tactile structure is centrally offset relative to the key, to minimize interference with through-key viewing of an image produced by the display device and associated with the key.

9. The computer peripheral of claim 1, wherein a portion of the mechanical understructure is formed with an optical prescription to produce a desired optical effect.

10. A method of manufacturing a computer peripheral, comprising:
providing a display device;
assembling a keyboard assembly from a base structure, a plurality of keycaps, and a plurality of mechanical understructures, wherein each of the plurality of mechanical understructures is operatively coupled between one of the plurality of keycaps and the base structure to guide and constrain movement of the keycap toward and away from the base structure; and
disposing the keyboard assembly over the display device so that images produced by the display device are viewable through the keyboard assembly, wherein each of the plurality of mechanical understructures is formed at least in part from transparent material to permit passage of light from the display device to a user of the keyboard assembly.

11. The method of claim 10, wherein for each of the plurality of mechanical understructures, the mechanical understructure is a scissors assembly formed by pivotably coupling a first rigid structure to a second rigid structure.

12. The method of claim 11, wherein each of the first rigid structure and the second rigid structure includes a pair of opposed legs held spaced apart by a pair of opposed rods, and wherein a first one of the pair of opposed legs of the first rigid structure is pivotably coupled to a first one of the pair of opposed legs of the second rigid structure, and wherein a second one of the pair of opposed legs of the first rigid structure is pivotably coupled to a second one of the pair of opposed legs of the second rigid structure.

13. The method of claim 12, wherein for each of the first rigid structure and the second rigid structure, each of the pair of opposed legs has a stepped, non-oblique configuration, in which a majority of surface area of the opposed leg is substantially parallel or substantially perpendicular to the display device when the scissors assembly is in a non-depressed rest position.

14. The method of claim 10, wherein for each of the plurality of mechanical understructures, forming the mechanical understructure includes providing a central aperture through the mechanical understructure.

15. The method of claim 14, wherein assembling the keyboard assembly includes, for each of the plurality of keycaps, centrally aligning the keycap with the central aperture of one of the plurality of mechanical understructures.

16. The method of claim 15, wherein assembling the keyboard assembly includes disposing a tactile structure on the base structure for each of the plurality of keycaps, the tactile structure being configured to provide tactile user feedback when the keycap is depressed from a rest position toward the base structure.

17. The method of claim 16, wherein the tactile structure for each of the plurality of mechanical understructures is centrally offset from the central aperture through the mechanical understructure.

18. The method of claim 10, wherein for each of the plurality of mechanical understructures, a portion of the mechanical understructure is formed with an optical prescription to produce a desired optical effect.

19. A computer peripheral, comprising:
a display device; and
a keyboard assembly disposed over the display device and configured to permit viewing of images produced by the display device through the keyboard assembly, the keyboard assembly including:
a plurality of keycaps; and
for each of the plurality of keycaps, a scissors assembly disposed between the keycap and a base structure of the keyboard assembly to guide reciprocating movement of the keycap toward and away from the base structure and display device, wherein the scissors assembly is at least partially transparent and has a non-oblique planar configuration, in which a majority of surface area of the scissors assembly is composed of planar surfaces that are either parallel or perpendicular to the display device.

20. The computer peripheral of claim 19, further comprising, for each of the plurality of keycaps, a tactile structure disposed on the base structure and configured to provide tactile user feedback when the keycap is depressed from a rest position toward the base structure, wherein the tactile structure is centrally offset from the keycap.
